(19) United States
(12) Patent Application Publication
(10) Pub. No.: US 2010/0277108 A1
(43) Pub. Date: Nov. 4, 2010

(54) Flexible LED illumination device

(76) Inventor: Joseph A. McDonnell, Weston, FL (US)

Correspondence Address: HARNESS, DICKEY & PIERCE, P.L.C., P.O. BOX 8910, RESTON, VA, 20195, US

(21) Appl. No.: 12/662,574

(22) Filed: Apr. 23, 2010

Related U.S. Application Data
(60) Provisional application No. 61/202,991, filed on Apr. 24, 2009.

(51) Int. Cl. H05B 37/02; F21V 19/00; F21V 21/08; H01J 9/24; F21V 19/02

(52) U.S. Cl. 315/360; 362/382; 362/396; 445/23; 362/418

(57) ABSTRACT

A portable illumination device having a flexible arm housing with an integrally formed LED lamp that is attachable to an object. The flexible arm may include a head portion housing an LED lamp, the head portion being unitarily formed in the flexible arm as a single integral unit at the time of manufacture. The flexible arm may be comprised of a non-slip material, such as rubber, to aid in positioning the flexible arm to a desired position.

### BACKGROUND

1. Field

The present invention relates to a flexible light emitting diode (“LED”) illumination device. More particularly, the present invention relates to a portable LED illumination device having a flexible arm housing an LED lamp, the illumination device being attachable to an object.

2. Description of Related Art

Known flexible lamps may include incandescent, halogen or fluorescent bulbs. Such bulbs are fraught with problems. For example, incandescent, halogen and fluorescent bulbs are large and require a large socket compared to an LED lamp. Incandescent and halogen bulbs are also very inefficient and have a short useful life due to heat generated during their use. Although somewhat more efficient than incandescent and halogen bulbs, fluorescent bulbs are overly large and have a useful life far less than that of an LED lamp. Moreover, incandescent, halogen and fluorescent bulbs are very fragile and may be easily damaged and/or have their useful life further shortened by even a slight impact.

Due to the many problems with incandescent, halogen and fluorescent bulbs, such bulbs present problems when incorporated into flexible lamps. Particularly, these bulbs are not useful in compact, portable light sources that are attachable to objects, such as handheld devices, that often require supplemental lighting for efficient use. For example, handheld devices, such as cell phones, PDA's, remote controls, books, maps, or the like, whether or not provided with a light source may require supplemental lighting during their use due to low lighting conditions, or automatic termination of a built-in light source.

### SUMMARY

In accordance with the present invention, a portable illumination device having a flexible arm housing with an integrally formed LED lamp is attachable to an object. In an example embodiment, the flexible arm may include a head portion housing an LED lamp, the head portion being unitarily formed in the flexible arm as a single integral unit at the time of manufacture. The flexible arm may be comprised of a non-slip material, such as rubber, to aid in positioning the flexible arm to a desired position.

In an example embodiment, the flexible arm is attached to a base housing a power source. The base may include control circuitry operatively connecting the LED lamp to the power source. The base may also include an actuating portion to switch the LED lamp on and off.

In an example embodiment, the base may include timer circuitry such that the LED light may be turned on for a predetermined period by manual activation of the actuating portion and turn off without manual activation of the actuating portion after the predetermined period.

In an embodiment, the illumination device may include an attachment portion on the base to attach the illumination device to an object. The attachment device may be attached to the base by a fastener. The attachment device may be configured to allow the illumination device to be attached to an object at any desired location.

### BRIEF DESCRIPTION OF THE DRAWINGS

The present invention will become more fully understood from the detailed description given below and the accompanying drawings, which are given for purposes of illustration only and thus, do not limit the invention. In the drawings which illustrate the best mode presently contemplated for carrying out the present invention:

FIG. 1 is a perspective view of an example embodiment of the illumination device;

FIG. 2 is a perspective view of an example embodiment of the illumination device;

FIG. 3 is an exploded view of the flexible arm of an example embodiment of the illumination device;

FIG. 4 is a side view of an example embodiment of the illumination device;

FIG. 5 is a perspective view of an example embodiment of the illumination device;

FIG. 6 is a schematic representation of an example embodiment of the illumination device

FIG. 7a shows an example embodiment of a flexible arm of the illumination device;

FIG. 7b shows an example of a bottom portion of a base of the illumination device; and

FIG. 8 shows an exploded view of an embodiment of the illumination device.

These drawings have been provided to assist in the understanding of the exemplary embodiments of the invention as described in more detail below and should not be construed as unduly limiting the invention. In particular, the relative spacing, positioning, sizing and dimensions of the various elements illustrated in the drawings are not drawn to scale and may have been exaggerated, reduced or otherwise modified for the purpose of improved clarity.

Those of ordinary skill in the art will also appreciate that a range of alternative configurations have been omitted simply to improve the clarity and reduce the number of drawings. Those of ordinary skill will appreciate that certain of the various process steps illustrated or described with respect to the exemplary embodiments may be selectively and independently combined to create other methods useful for manufacturing semiconductor devices without departing from the scope and spirit of this disclosure.

### DETAILED DESCRIPTION

Referring now to the drawings in which like reference numerals designate like or corresponding parts throughout the several views, there is shown an example embodiment of a flexible LED illumination device, shown merely for the purpose of illustration. One skilled in the art will readily recognize from the following description, taken in conjunction with the accompanying drawings and claims, that the principles of the present invention may be applicable to other embodiments other than that shown for purposes of illustration in the drawings.

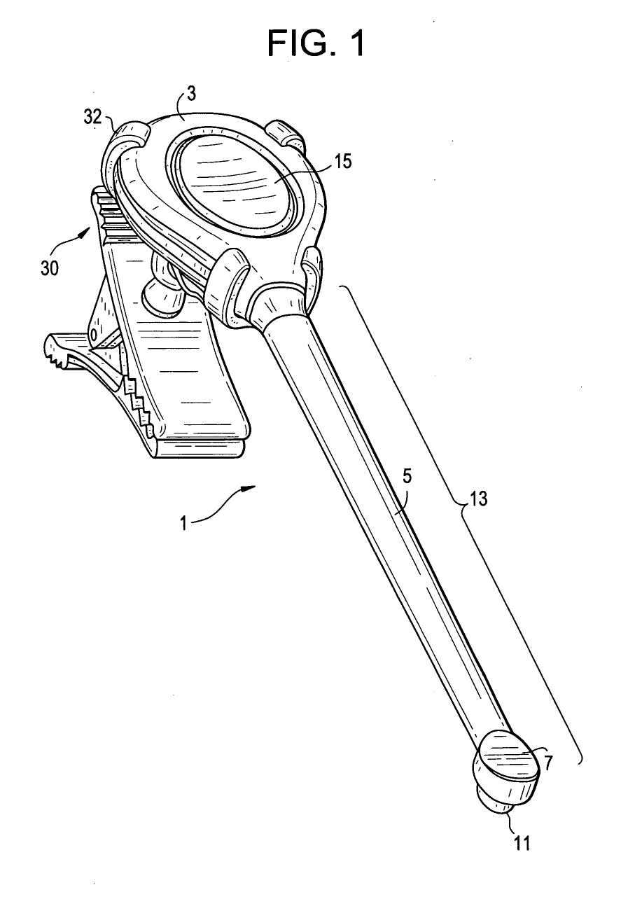

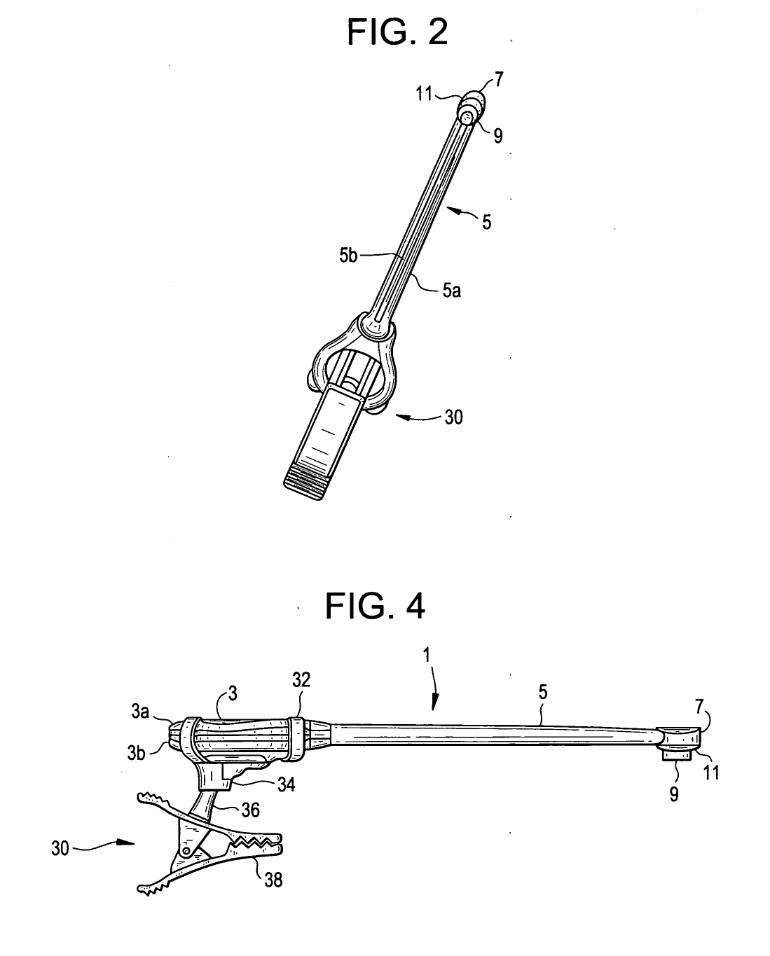

As shown in FIG. 1, the flexible illumination device 1 may include a base portion 3 and a flexible arm portion 5 extending from the base portion 3. The flexible arm portion S includes a head portion 7. An LED 9 may be housed in the head portion 7 (FIG. 2). In an example embodiment, a hood portion 11 may extend from a surface of the head portion 7 and surround the LED 9 thereby forming shade and to further protect the LED 9 from damage. The head portion 7 may be integrally formed with the flexible arm portion 5 providing a unitary flexible arm and head.

In an example embodiment, the flexible arm portion 5 is plastically deformable such that the flexible arm portion 5 may be reconfigurably positioned in any desired orientation. The flexible arm portion 5 may be formed of a rubber, silicone or other malleable, non-slip material to aid in positioning the flexible arm portion 5 in a desired position. In an example embodiment, the flexible arm portion 5 may include a flexible, ductile member, such as a wire or other malleable material that allows the flexible arm to be repositionable to a desired position, within the non-slip material to aid in the positioning of the flexible arm portion 5.

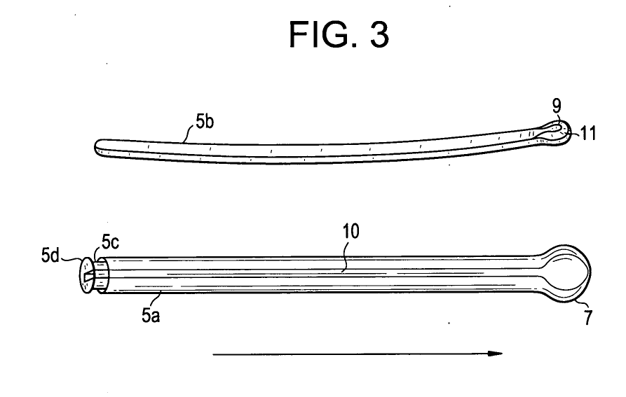

The flexible arm portion 5, head portion 7, LED 9 and hood portion 11 comprise an integrated light assembly 13. The light assembly 13 is integrally formed as a single piece unitary body during manufacture. As shown in the example embodiment in FIG. 3, the flexible arm portion 5 may include an outer member 5a having a channel 10 formed in a longitudinal direction (shown by arrow) of the flexible arm 5. The head portion 7 extends from a terminal end of the outer member 5a. An inner member 5b includes the hood portion 11 and fits into the channel 10. The LED 9 is fitted into the hood portion 11 such that the hood portion 11 surrounds side surfaces of the LED 9. The hood portion and the LED 9 are fitted into the head portion 7 and sealed therein. The inner member 5b may be sealed in the channel 10 by one or more of an adhesive, welding, thermal bonding, or the like. Electrical wires 65 are connected to the LED 9 and pass along the channel 10 of the outer member 5a and are covered by the inner member 5b.

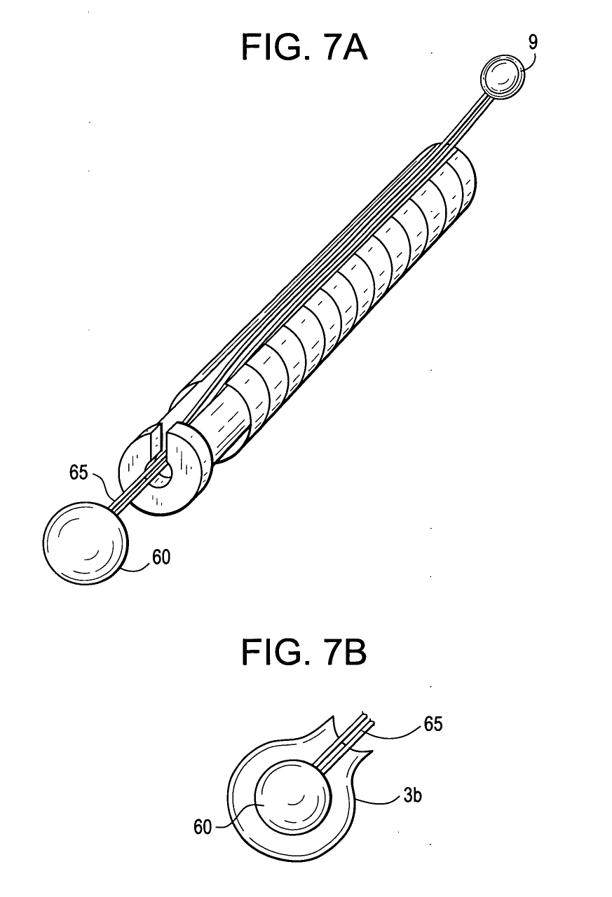

In an embodiment, the flexible member that provides the malleability of the flexible arm 5 may be one or more of the wires 65 connected to the LED 9. The wires 65 may also be connected to a power source 60 housed in the base 3. In an example embodiment, at least one of the wires 65 is of sufficient gauge to provide a plastically deformable inner core of the flexible arm 5 such that the wire plastically deforms under stress to a desired position of the flexible arm 5. For example a wire 65 may be a 10-16 gauge wire. Although a 10-16 gauge wire is provided as an example, wires of other gauges may suffice (FIG. 7a, 7b).

In an example embodiment, a wire providing a plastically deformable inner core may not be attached operatively connected to the LED 9 or the power source 60, but may be disposed within the flexible arm 5 to allow the arm to be re-positionable to a desired configuration. In addition to being disposed in the channel 10 the wires 65 may be also be embedded in the outer member 5a and/or the inner member 5b.

The flexible arm portion 5 may further include a narrowed portion 5c at an end opposite the head portion 7 and an enlarged end 5d, connected to the narrowed portion 5c, at an end most portion of the flexible arm portion 5. The flexible arm portion 5 may be formed by molding, extruding or other process to create a unitary light assembly 13.

In an example embodiment, the base 3 may be formed in two pieces as a top piece 3a and a bottom piece 3b (FIG. 4) forming a cavity therebetween. The top piece 3a and the bottom piece 3b may be held together with fasteners, such as screws. The base portion 3 houses a power source, such as a battery, to power the LED 9. The base may also include an actuator 15 or switch on a surface thereof to turn the LED 9 on and off. The power source and the actuator 15 are operatively connected to control circuitry housed within the base portion 3. Electrical wires (not shown) are integrally formed within the arm portion 5 and electrically connect the LED 9 with the control circuitry and the power source.

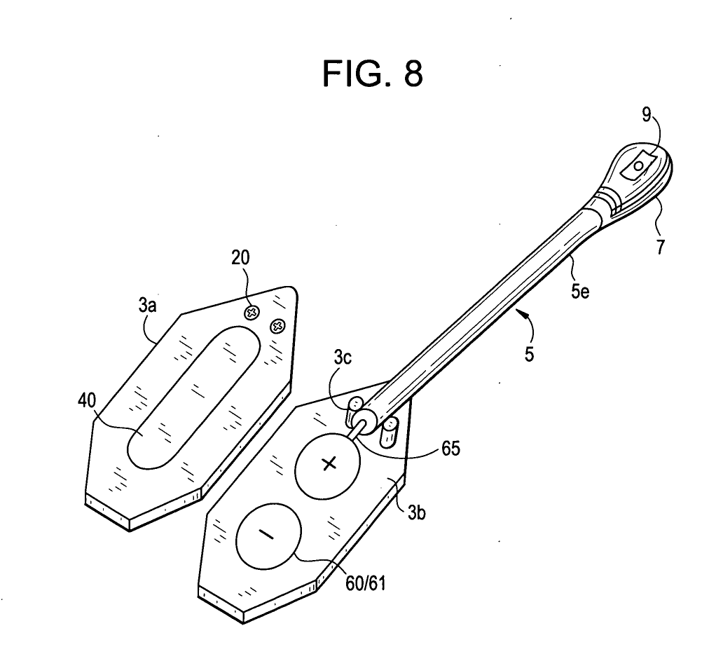

As shown in FIG. 8, in an example embodiment, the flexible arm 5 may be a joint-less repositionable arm having a plastically deformable inner core 65 comprised of a ductile material such as a wire of a gauge sufficient to be malleable without breaking. The inner core 65 may be covered by a resilient outer sheath 5e. The sheath 5e may be of a non-slip material to aid in the positioning of the arm to a desired configuration.

The arm may include a light emitting diode (LED) 9 at a terminal end of the repositionable arm 5. As shown in FIG. 8, the LED 9 may be housed within a cap or head 7 made of a plastic or other material sufficient to protect the LED 9. The other end of the arm may be captured between a top portion 3a and a bottom portion 3b of the base 3 that together form a cavity therebetween. The base 3 may also include a pair of alignment posts 3c in the cavity. The repositionable arm 5 may be captured between the alignment posts 3c. The sheath 5e may be captured in the dead 7 and/or the base 3. In an embodiment the alignment posts 3c may also receive screws 20 that secure the top and bottom portions 3a, 3b of the base 3 together (FIG. 8).

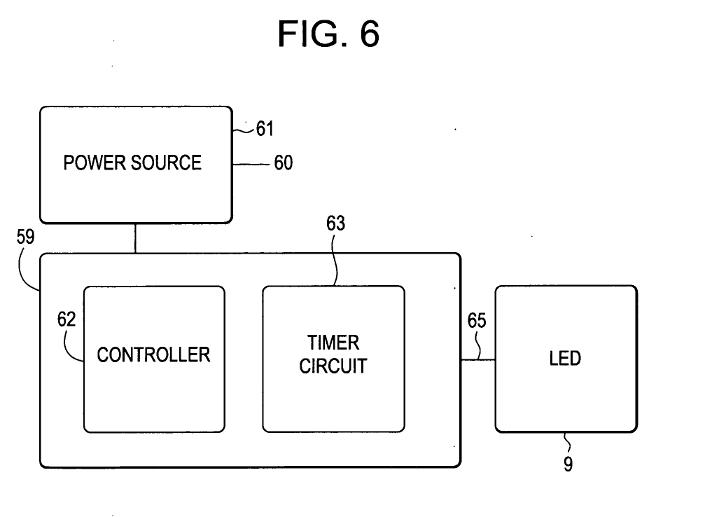

In an example embodiment, the control circuitry 59 is shown in FIG. 6. The constituent elements of the control circuitry 59 include a power source 60 (such as a battery 61), a controller 62 having timer circuitry 63 that, upon activation of the actuator 15, automatically turns off the LED 9 after a desired (or, alternatively, a predetermined) time period, and electrical wires 65 for connecting the controller 62 and battery 61 to the LED 9. In an example embodiment, the power source 60 includes a battery 61, which is small enough to fit in the housing with a sufficient useful life to illuminate the LED 9 several times. For example, upon activating the flexible illumination device 1, the LED 9 will turn off after a 20 second period. The deactivation of the LED after the desired period is “hands-free” thereby allowing the user to set the illumination period for the time period without requiring manual deactivation. While a 20 second period is described, the control circuitry 59 may be configured to terminate light emission from the LED 9 after another time period. In an example embodiment, pushing the actuator once will result in the LED being illuminated for the 20 second period, while pushing the actuator two times will result in the LED remaining illuminated until the actuator is pushed again, (i.e., a third time) thereby turning the LED off.

The flexible arm portion 5 is secured to the base portion 3 by capturing the narrowed portion 5c between walls of the top portion 3a and the bottom portion 3b of the base portion 3 such that the enlarged portion is within the cavity formed between the top portion 3a and the bottom portion 3b of the base portion 3. The electrical wires pass through the narrowed portion 5c and the enlarged portion 5d and are connected to the control circuitry.

In an example embodiment, the flexible illumination device 1 may include an attachment portion 30 (FIGS. 1 and 4) at the base portion 3. The attachment portion may be detachably attached to the base portion. In an example embodiment, the attachment portion 30 may include a body 32 having a plurality of attachment arms 34 extending therefrom. The attachment arms 34 are configured to extend around a portion of the base 3 portion to secure the base portion 3 to the body 32 of the attachment portion 30. A stem 36 is movably affixed to the body 32 such that the body 32 may rotate and/or pivot on the stem 36. A clip portion 38 extends from the stem at an end opposite the body 32.

In operation, the flexible illumination device 1 may be removably attached to an object at the attachment portion 30 via the clip portion 38. Once attached to the object, a position of the flexible illumination device may be adjusted by rotating and/or pivoting the body 32 on the stem 36. The flexible illumination device may be further positioned by bending the arm portion 5 so that the LED 9 is at a desired and/or optimum position.

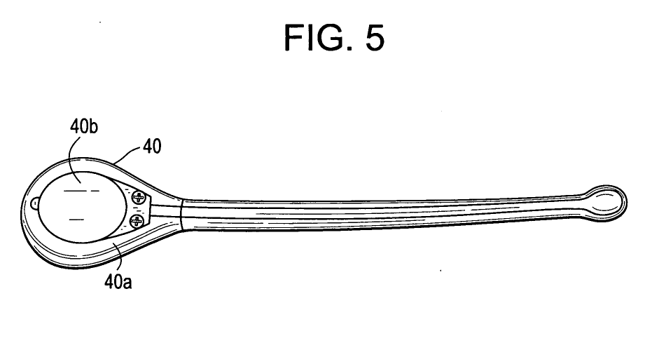

In an example embodiment, the attachment portion 30 (FIG. 5) may include a hook and loop fastener 40 adhered to the base portion 3. In the embodiment, a first part 40a of the hook and loop fastener may be adhered to a surface of the base portion 3 and a second part 40b of the hook and loop fastener may be attached to an object (not shown) to which the flexible illumination device 1 is to be attached. In this way, the flexible illumination device 1 may be detachably attached to the object.

The above detailed description describes example embodiments of the present invention. Persons skilled in the art will recognize that alternative embodiments are possible without departing from the scope and spirit of the present invention. The above detailed description describes different embodiments of the present invention. For example, the example embodiments of the portable pressure point massage bed discussed may be made of a variety of materials without departing from the scope and intent of this invention.

What is claimed is:

1. An illumination device, comprising:
a base including an actuator;
a flexible arm portion attached to the base, the flexible arm portion including,
an outer member having a channel formed longitudinally therein, the outer member having a head portion formed at a terminal end thereof; and
an inner member disposed in the channel, the inner member including a light emitting diode (LED) structurally integrated at a terminal portion thereof.

2. The illumination device of claim 1, wherein the head portion includes a hood portion integrally formed on the flexible arm portion, the hood portion surrounding and extending beyond an emitting surface of the LED.

3. The illumination device of claim 1, wherein the flexible arm is comprised of a non-slip material.

4. The illumination device of claim 3, wherein the non-slip material surrounds a repositionable material that extends along a length of the arm.

5. The illumination device of claim 1, wherein the flexible arm includes a narrowed portion at an end opposite the head portion.

6. The illumination device of claim 5, wherein the flexible arm further includes an enlarged end connected to the narrowed portion.

7. The illumination device of claim 6, wherein the base includes a top portion and a bottom portion fittable together and forming a cavity therebetween.

8. The illumination device of claim 7, wherein the narrowed portion of the flexible arm is captured between walls of the top and the bottom portions of the base.

9. The illumination device of claim 7, wherein the enlarged portion of the flexible arm is captured within the cavity formed between the top and the bottom portions of the base.

10. The illumination device of claim 7, wherein the illumination device further includes a power source in the cavity, the power source being operatively connected to the LED.

11. The illumination device of claim 7, wherein the illumination device further includes control circuitry within the cavity, the control circuitry being operatively connected to the power source and the LED.

12. The illumination device of claim 11, wherein the control circuitry is configured to control a period of illumination of the LED.

13. The illumination device of claim 12, wherein the period of illumination is selectable by activation of the actuator and the control circuit is further configured to deactivate the LED after a determined period of illumination.

14. The illumination device of claim 1, further including an attachment portion detachably connected to the base for attaching the illumination device to an object.

15. The illumination device of claim 14, wherein the attachment portion includes a body having arms extending therefrom that capture the base.

16. The illumination device of claim 14, wherein the attachment portion includes a stem attached to the body at a first end and a clip at a second end and at least one of the body and the clip are movable on the stem.

17. A method of manufacturing an illumination device, comprising:
providing a first flexible member having a channel formed longitudinally therein;
providing a second flexible member including a light emitting diode at a terminal portion thereof;
inserting the second flexible member into the channel of the first flexible member;
securing the first and second flexible members together forming a flexible arm;
attaching the flexible arm to a base member that includes a power supply and an actuator.

18. The method of claim 17, further comprising:
providing a light assembly by forming the first flexible member and the second flexible member as a single piece unitary body.

19. An illumination device, comprising:
a base including an actuator;
a repositionable arm attached to the base, the repositionable arm portion including,
an outer member having a channel formed longitudinally therein, the outer member having a head portion formed at a terminal end thereof;
an inner member disposed in the channel, the inner member including a light emitting diode (LED) structurally integrated at a terminal portion thereof; and
a plastically deformable inner core within the repositionable arm.

20. An illumination device, comprising:
a base having a top portion and a bottom portion fittable together and forming a cavity therebetween;
a joint-less repositionable arm captured between the top portion and the bottom portion of the base, the repositionable arm portion including a plastically deformable inner core and a resilient outer sheath;
a light emitting diode (LED) structurally integrated at a terminal portion thereof of the repositionable arm, wherein the base further includes a pair of alignment posts in the cavity, and the repositionable arm is captured between the alignment posts.

21. The illumination device of claim 20, further including a head portion clamped around the outer sheath, wherein the LED is housed in the head portion.
